(19) United States
(12) Patent Application Publication
(10) Pub. No.: US 2017/0177088 A1
(43) Pub. Date: Jun. 22, 2017

(54) TWO-STEP GESTURE RECOGNITION FOR FINE-GRAIN CONTROL OF WEARABLE APPLICATIONS

(71) Applicant: SAP SE, Walldorf (DE)

(72) Inventor: Philip Miseldine, Karlsruhe (DE)

(21) Appl. No.: 14/976,464

(22) Filed: Dec. 21, 2015

(51) Int. Cl. G06F 3/01; G06F 1/16

(52) U.S. Cl. CPC G06F 3/017; G06F 1/163

(57) ABSTRACT

The present disclosure provides methods, devices, systems, and computer program products for providing fine-grain gesture-based control of wearable applications. Methods are provided for multi-step gesture-based control systems of wearable applications with an initial, easy to recognize gesture being used to place the device in a state that subtle gestures can be identified that can control navigation and interactivity on the device that rely on the user being able to view the device. Systems and methods are provided for utilizing data obtained from sensor(s) to determine a gesture to place a wearable device in a state of fine-grain gesture-based control.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyrights whatsoever.

### BACKGROUND

Gestures, where a user indicates an intention to a computing device via physical movement, are well-established and widely used input mechanisms. For example, swiping or tapping fingers across a screen to aid navigation, or shaking a device to undo an action are common embodiments. Gestures are particularly useful where input mechanisms are limited due to a device's size, for example mobile devices and wearable devices, particularly smart watches. With wearable devices having such limited screen space to allow for interaction, current smart watches have gestures controlled by the movement of the wrist and/or arm so that the user does not need to interact directly with the screen, but rather just with their body. For example, current smart watches may turn on when the wearer lifts their wrist to look at the device, or use strong upwards or downwards movements of the arm to navigate back and forth within an application context.

However, gestures can be difficult to identify against normal body movement patterns, especially in wearable devices that move naturally with the body, such as smart watches. In order to aid distinction, gestures are typically embodied as simplistic, broad motions which can be easily identified. This limits the possibilities of what kinds of gestures can be used to control the device. On a small wearable device such as a smart watch, gestures that are distinct enough to reliably distinguish a deliberate user action from natural body movement make the device unusable and/or uncontrollable in the moments the gesture is being performed. That is, the gesture either removes the device screen from view or puts the device in motion, thereby making it impossible to interact with. For example, gesture-based scrolling, as currently implemented, requires a broad up or down motion which eliminates the screen from view as the user twists their wrist.

### BRIEF DESCRIPTION OF THE DRAWINGS

FIG. 1 shows a flow chart by which the two-step gesture control proceeds according to an example embodiment.

FIG. 2 shows exemplary gestures according to an example embodiment.

FIG. 3 shows an exemplary architecture of a wearable device according to an example embodiment.

### DETAILED DESCRIPTION

Example embodiments of the present disclosure provide for a method, device, system, and computer program product for providing two-step gesture recognition providing for fine-grain control of wearable devices.

Most gesture recognition systems rely on input from a series of sensors to detect user action. In order to eliminate the possibility of an excess number of false positives in the detection of gestures, especially with those devices worn on the body and thus prone to normal body movement, most gestures require the sensors to give a strong indicator of a particular movement, such as a total movement in one axis, or a long finger press or swipe. Having fine-grain control over interactivity of a wearable device is therefore limited where a minimal change in a sensor could easily be used to control user interface (UI) navigation tasks such as scrolling or element clicks, as these movements could typically be created via natural movement.

Provided is a two-step approach to gesture control that eliminates the above issues of requiring gestures to be so distinct as to render the wearable application otherwise unusable during the performance of the gesture. In a first step, the user is required to indicate their desire to use fine-grain gestures to control the device via a broad, easily recognizable “initialization” gesture. Then, the user can perform subtle gestures for fine-grain control of the device while maintaining usability, i.e., viewability of the device screen and allowing interaction.

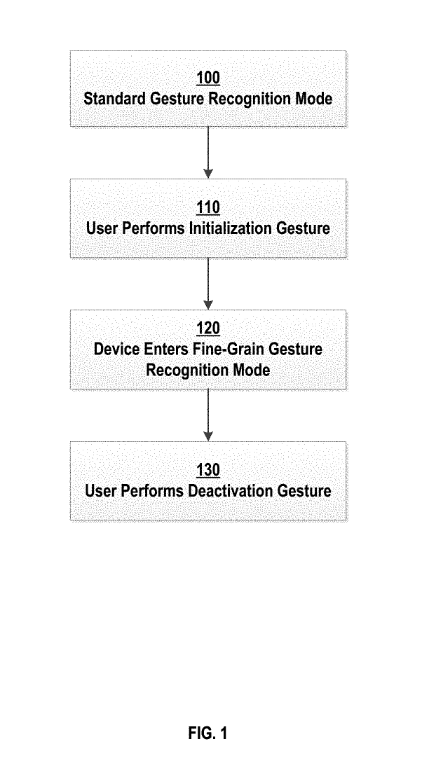

FIG. 1 shows a flow diagram by which the two-step gesture control of a wearable device proceeds according to an example embodiment. In one embodiment, the wearable device is initially in a standard gesture-based control mode, as shown in box 100. In the standard gesture-based control mode, the device may only recognize and respond to gestures that have a low false positive rate. That is, the device may only recognize and respond to gestures that are unlikely to occur as a result of natural movement.

In one embodiment, the wearable device recognizes a user gesture as input by detecting signals transmitted from sensors. In some embodiments, the signals detected from the sensors must exceed some threshold to be interpreted as a gesture. In other embodiments, the signals detected from the sensors match a signal stored in the device as representing a particular gesture. In some embodiments, the signals to be detected are transmitted from one or more sensors.

In some embodiments, the sensors may comprise an accelerometer. An accelerometer can determine the position of the device in 3D space. In another embodiment, the sensors may comprise a touch-sensitive screen. A touch-sensitive screen allows finger movements of the user to be detected. In some embodiments, the sensors may comprise a gyroscopic sensor. A gyroscopic sensor can determine the orientation of the device in 3D space. In another embodiment, the series of sensors comprises a light sensor. A light sensor may be used to detect a change in the ambient light level. In another embodiment, the series of sensors comprises a camera. A camera may be used to detect user movement. In some embodiments, the sensors may comprise one, some, or all of these sensors. It is to be understood by those of skill in the art that any sensor or signal that may be utilized to detect a user's gesture and/or intention can be used in the context of the present disclosure.

The wearable device transitions from a standard gesture-recognition mode to a fine-grain gesture-recognition mode via an initialization gesture detected from signals transmitted by sensors. In box 110, the user performs an initialization gesture to place the device in a fine-grain gesture-recognition mode. In some embodiments, the initialization gesture is one with a very low false positive rate, i.e., is unlikely to occur as a result of natural movement. Example initialization gestures may include, but are not limited to, tapping three times in succession on the screen of the device, or moving the arm upwards fully, and then down fully. It is to be understood that any gesture with a sufficiently low false-positive rate may be implemented as an initialization gesture.

In some embodiments, the initialization gesture may be predefined at the device, operating system, or application level. In other embodiments, the initialization gesture may be user-defined. In some embodiments, the device may indicate to the user that the initialization gesture has been recognized by, for example, providing visual or haptic feedback.

In box 120, the wearable device is now in fine-grain gesture-recognition mode. In some embodiments, fine-grain gesture recognition mode may allow the device to detect gestures at a higher accuracy than in normal gesture-recognition mode. That is, the device may detect gestures that would arise during normal body movement and thus have been ignored in the standard gesture-recognition mode. In some embodiments, the threshold that detected signals must exceed to be recognized as gestures is lowered in fine-grain gesture-recognition mode. In some embodiments, the fine-grain gesture-recognition mode allows the device to detect gestures that maintain usability of the wearable device. That is, the fine-grain gesture-recognition mode may allow the user to utilize gestures while maintain viewability of the device's screen.

In box 130, once the user has completed their need for fine-grain gesture-recognition mode, the user may perform a deactivation gesture to place the device back in standard gesture-recognition mode.

In some embodiments, return to standard gesture-recognition mode may not require a deactivation gesture, or be deactivated in another manner. For example, the device may return to standard gesture-recognition mode if the user closes the application they were using. In other embodiments, the device may return to standard gesture-recognition mode if the sensors, e.g. a camera, detect that the user is no longer viewing the screen. In another embodiment, the device may return to standard gesture-recognition mode if the sensors, e.g. an accelerometer and/or a gyroscopic sensor, determine that the user has returned the device to an unusable position, e.g. a smart watch device has been placed by the user's side. It is to be understood by one of ordinary skill in the art that fine-grain gesture-recognition mode may be deactivated in a variety of manners as appropriate in the context of use.

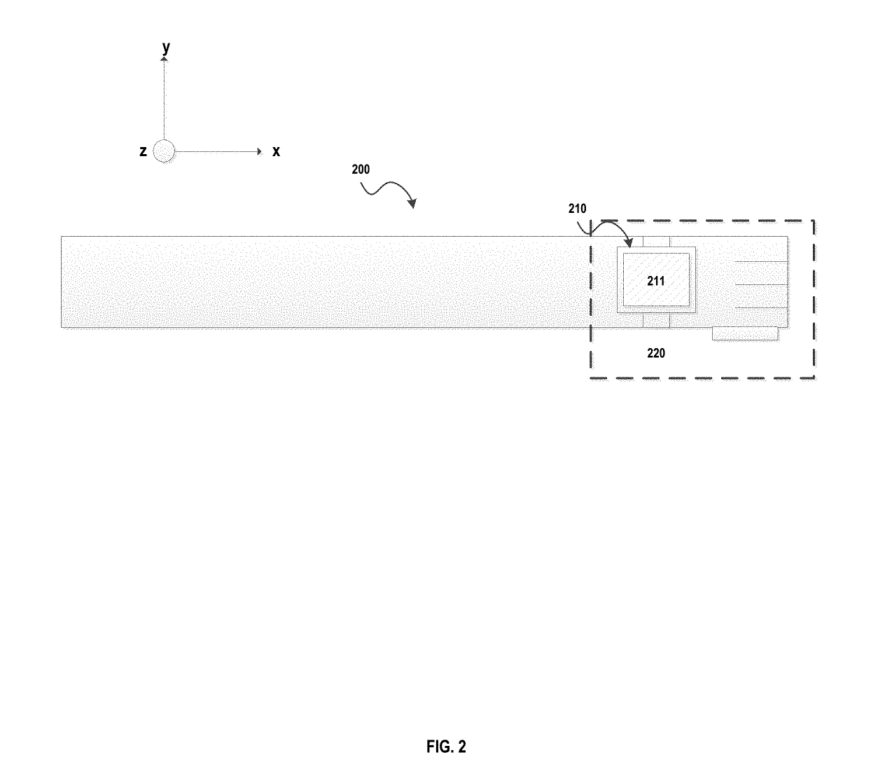

In FIG. 2, a wearable device demonstrating fine-grain gesture-recognition mode is shown. User 200 is wearing a smart watch 210 comprising a screen 211. The screen is displaying content 220. As is illustrated by the dotted lines, content 220 extends beyond the edges of screen 211. After performing an initialization gesture and placing the device in fine-grain gesture-recognition mode, the user may tilt the device along the z/x-axis to pan left and right, or along the z/y-axis to scroll up and down throughout content 220. The user may move their wrist upwards and downwards along the z-axis to zoom into and out of content 220. In some embodiments, the degree of tilt may adjust the rate at which content 220 is panned or scrolled. In this manner, the use of fine-grain gesture-recognition mode allows the user to maintain visibility of screen 211 as the subtle gestures are being performed, allowing the user to, for example, know when to stop scrolling or panning.

In some embodiments, once the system is in fine-grain gesture-recognition mode, the first UI element that can be interacted with can be visually highlighted. The user can push their wrist away from them to cycle through each UI element on the screen. Other gestures may then be used to control that UI element. In another embodiment, all user interface elements can respond to successive gestures. Example gestures that may be used while the device is in fine-grain gesture-recognition mode include, but are not limited to: tilting the device along the z/x-axis to scroll through truncated text of the selected UI element; tilting the device along the z/y-axis to scroll up or down if the UI element has off-screen content (such as a list, text box, etc.); moving their wrist along the x-axis to turn the view to the next UI element (such as the next page in a multi-page application; moving their wrist along the z-axis to zoom in and out of content).

In some embodiments, in addition to navigation, fine-grain gesture-recognition mode may also allow a user to indicate a particular action to take place on either the selected UI element, or a global action contextualized to the currently viewed content (such as a Submit button, or a context menu). Example actions include, but are not limited to: a user flicking their wrist gently away from them to indicate a click/tap or a global accept; a user flicking their wrist towards them to indicate a cancel command; a user shaking their wrist to indicate an exit command; a user swirling their wrist to indicate a refresh command; a user gently moving the device up and down to indicate an undo command.

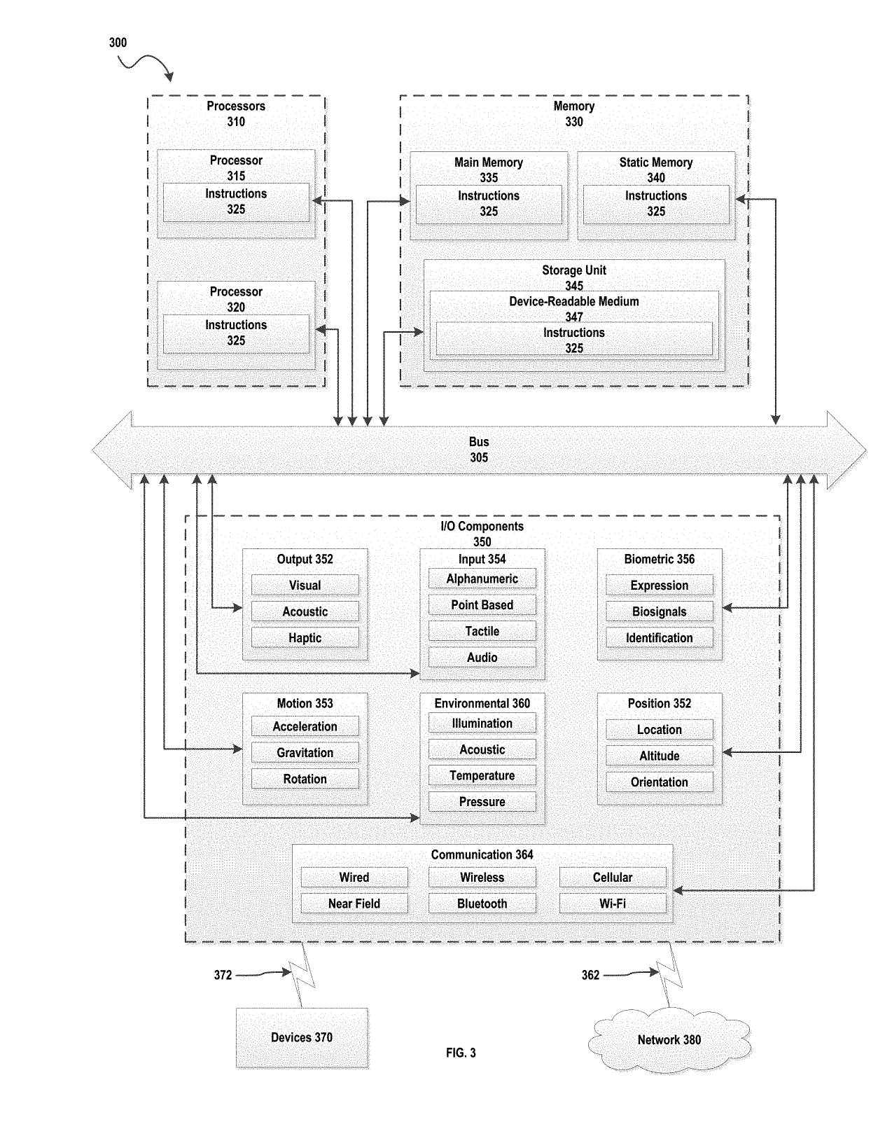

FIG. 3 is a block diagram illustrating components of a wearable device 300, according to some example embodiments, able to read instructions from a device-readable medium (e.g., a device-readable storage medium) and perform any one or more of the methodologies discussed herein. Specifically, FIG. 3 shows a diagrammatic representation of the device 300 in the example form of a computer system, within which instructions 325 (e.g., software, a program, an application, an applet, an app, or other executable code) for causing the device 300 to perform any one or more of the methodologies discussed herein may be executed. In alternative embodiments, the device 300 operates as a standalone device or may be coupled (e.g., networked) to other devices. In a networked deployment, the device 300 may operate in the capacity of a server device or a client device in a server-client network environment, or as a peer device in a peer-to-peer (or distributed) network environment, e.g., as a smart watch paired with a smartphone. The device 300 may comprise, but be not limited to, wearable devices such as a smart watch, a fitness tracker, a wearable control device, or any device capable of executing the instructions 325, sequentially or otherwise, that specify actions to be taken by device 300. Further, while only a single device 300 is illustrated, the term “device” shall also be taken to include a collection of devices 300 that individually or jointly execute the instructions 325 to perform any one or more of the methodologies discussed herein.

The device 300 may include processors 310, memory 330, and I/O components 350, which may be configured to communicate with each other via a bus 305. In an example embodiment, the processors 310 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 315 and processor 320 that may execute instructions 325. The term “processor” is intended to include multi-core processor that may comprise two or more independent processors (also referred to as “cores”) that may execute instructions contemporaneously. Although FIG. 3 shows multiple processors 310, the device 300 may include a single processor with a single core, a single processor with multiple cores (e.g., a multi-core process), multiple processors with a single core, multiple processors with multiples cores, or any combination thereof.

The memory 330 may include a main memory 335, a static memory 340, and a storage unit 345 accessible to the processors 310 via the bus 305. The storage unit 345 may include a device-readable medium 347 on which are stored the instructions 325 embodying any one or more of the methodologies or functions described herein. The instructions 325 may also reside, completely or at least partially, within the main memory 335, within the static memory 340, within at least one of the processors 310 (e.g., within a processor's cache memory), or any suitable combination thereof, during execution thereof by the device 300. Accordingly, the main memory 335, static memory 340, and the processors 310 may be considered as device-readable media 347.

As used herein, the term “memory” refers to a device-readable medium 347 able to store data temporarily or permanently and may be taken to include, but not be limited to, random-access memory (RAM), read-only memory (ROM), buffer memory, flash memory, and cache memory. While the device-readable medium 347 is shown in an example embodiment to be a single medium, the term “device-readable medium” should be taken to include a single medium or multiple media (e.g., a centralized or distributed database, or associated caches and servers) able to store instructions 325. The term “device-readable medium” shall also be taken to include any medium, or combination of multiple media, that is capable of storing instructions (e.g., instructions 325) for execution by a device (e.g., device 300), such that the instructions, when executed by one or more processors of the device 300 (e.g., processors 310), cause the device 300 to perform any one or more of the methodologies described herein. Accordingly, a “device-readable medium” refers to a single storage apparatus or device, as well as “cloud-based” storage systems or storage networks that include multiple storage apparatus or devices. The term “device-readable medium” shall accordingly be taken to include, but not be limited to, one or more data repositories in the form of a solid-state memory (e.g., flash memory), an optical medium, a magnetic medium, other non-volatile memory (e.g., Erasable Programmable Read-Only Memory (EPROM)), or any suitable combination thereof. The term “device-readable medium” specifically excludes non-statutory signals per se.

The I/O components 350 may include a wide variety of components to receive input, provide and/or produce output, transmit information, exchange information, capture measurements, and so on. It will be appreciated that the I/O components 350 may include many other components that are not shown in FIG. 3. In various example embodiments, the I/O components 350 may include output components 352 and/or input components 354. The output components 352 may include visual components (e.g., a display such as a plasma display panel (PDP), a light emitting diode (LED) display, a liquid crystal display (LCD), acoustic components (e.g., speakers), haptic components (e.g., a vibratory motor), other signal generators, and so forth. The input components 354 may include alphanumeric input components (e.g., a touch screen configured to receive alphanumeric input), point-based input components (e.g., a motion sensor, and/or other pointing instrument), tactile input components (e.g., a physical button, a touch screen that provides location and force of touches or touch gestures, and/or other tactile input components), audio input components (e.g., a microphone), and the like.

In further example embodiments, the I/O components 350 may include biometric components 356, motion components 358, environmental components 360, and/or position components 362 among a wide array of other components. For example, the biometric components 356 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, finger print identification, or electroencephalogram based identification), and the like. The motion components 358 may include acceleration sensor components (e.g., accelerometer), gravitation sensor components, rotation sensor components (e.g., gyroscope), and so forth. The environmental components 360 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e g, infrared sensors that detect nearby objects), and/or other components that may provide indications, measurements, and/or signals corresponding to a surrounding physical environment. The position components 362 may include location sensor components (e.g., a Global Position System (GPS) receiver component), altitude sensor components (e.g., altimeters and/or barometers that detect air pressure from which altitude may be derived), orientation sensor components (e.g., magnetometers), and the like.

Communication may be implemented using a wide variety of technologies. The I/O components 350 may include communication components 364 operable to couple the device 300 to a network 380 and/or devices 370 via coupling 382 and coupling 372 respectively. For example, the communication components 364 may include a network interface component or other suitable device to interface with the network 380. In further examples, communication components 364 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 370 may be another device (e.g., a smartphone coupled via Bluetooth®).

Moreover, the communication components 364 may detect identifiers and/or include components operable to detect identifiers. For example, the communication components 364 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), acoustic detection components (e.g., microphones to identify tagged audio signals), and so on. In additional, a variety of information may be derived via the communication components 364, such as location via Internet Protocol (IP) geo-location, location via Wi-Fi® signal triangulation, location via detecting a NFC beacon signal that may indicate a particular location, and so forth.

In various example embodiments, one or more portions of the network 380 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 380 or a portion of the network 380 may include a wireless or cellular network and the coupling 382 may be a Code Division Multiple Access (CDMA) connection, a Global System for Mobile communications (GSM) connection, or other type of cellular or wireless coupling. In this example, the coupling 382 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3 G, fourth generation wireless (4 G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 325 may be transmitted and/or received over the network 380 using a transmission medium via a network interface device (e.g., a network interface component included in the communication components 364) and utilizing any one of a number of well-known transfer protocols (e.g., hypertext transfer protocol (HTTP)). Similarly, the instructions 325 may be transmitted and/or received using a transmission medium via the coupling 372 (e.g., a peer-to-peer coupling) to devices 370. The term “transmission medium” shall be taken to include any intangible medium that is capable of storing, encoding, or carrying instructions 325 for execution by the device 300, and includes digital or analog communications signals or other intangible media to facilitate communication of such software.

Furthermore, the device-readable medium 347 is non-transitory (in other words, not having any transitory signals) in that it does not embody a propagating signal. However, labeling the device-readable medium 347 as “non-transitory” should not be construed to mean that the medium is incapable of movement; the medium should be considered as being transportable from one physical location to another. Additionally, since the device-readable medium 347 is tangible, the medium may be considered to be a device-readable medium. The foregoing description has been presented for purposes of illustration and description. It is not exhaustive and does not limit embodiments of the disclosure to the precise forms disclosed. Modifications and variations are possible in light of the above teachings or may be acquired from the practicing embodiments consistent with the disclosure. For example, some of the described embodiments may include software and hardware, but some systems and methods consistent with the present disclosure may be implemented in software or hardware alone.

Based on the teachings contained in this disclosure, it will be apparent to persons skilled in the relevant art(s) how to make and use the disclosure using data processing devices, computer systems, and/or computer architectures other than that shown in FIG. 3. In particular, embodiments may operate with software, hardware, and/or operating system implementations other than those described herein.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

In addition, in the foregoing Detailed Description, various features may be grouped or described together for the purpose of streamlining the disclosure. This disclosure is not to be interpreted as reflecting an intention that all such features are required to provide an operable embodiment.

1. A method for fine-grain gesture-based control of a wearable device:
generating signal data from at least one sensor, wherein the generated signal data exceeds a gesture recognition threshold;
comparing the generated signal data to stored signal data representing an initialization gesture; and
activating a fine-grain gesture recognition mode if the generated signal data matches the stored signal data, the fine-grain gesture recognition mode lowering the gesture recognition threshold; and
providing, concurrent with the activation of the fine-grain gesture recognition mode, visual or haptic feedback to the user indicating that the initialization gesture has been recognized.

2. The method of claim 1, wherein the gesture recognition threshold is determined by a comparison of the generated signal data to signals generated as a result of natural body movement.

3. (canceled)

4. The method of claim 1, further comprising generating additional signal data from the at least one sensor, wherein the additional generated signal data exceeds the lowered gesture recognition threshold.

5. The method of claim 1, further comprising:
generating additional signal data, wherein the generated additional signal data exceeds the gesture recognition threshold;
comparing the generated additional signal data to stored signal data representing a deactivation gesture; and
deactivating fine-grain gesture recognition mode if the generated additional data matches the stored signal data representing the deactivation gesture.

6. The method of claim 5, wherein deactivating fine-grain gesture recognition mode raises the gesture recognition threshold.

7. A non-transitory computer readable storage medium storing one or more programs configured to be executed by a processor, the one or more programs comprising instructions for:
receiving signal data from at least one sensor that exceeds a gesture recognition threshold;
comparing the received signal data to stored signal data representing an initialization gesture;
activating a fine-grain gesture recognition mode if the received signal data matches the stored signal data, the fine-grain gesture recognition mode lowering the gesture recognition threshold; and
providing, concurrent with the activation of the fine-grain gesture recognition mode, visual or haptic feedback to the user indicating that the initialization gesture has been recognized.

8. The non-transitory computer readable storage medium of claim 7, wherein the gesture recognition threshold is determined by a comparison of the received signal data to signals generated as a result of natural body movement.

9. (canceled)

10. The non-transitory computer readable storage medium of claim 7, wherein the one or more programs further comprise instructions for generating additional signal data from the at least one sensor, wherein the additional generated signal data exceeds the lowered gesture recognition threshold.

11. The non-transitory computer readable storage medium of claim 7, wherein the one or more programs further comprise instructions for:
receiving additional signal data from the at least one sensor that exceeds the gesture recognition threshold;
comparing the received additional signal data to stored signal data representing a deactivation gesture; and
deactivating fine-grain gesture recognition mode if the received additional data matches the stored data representing the deactivation gesture.

12. The non-transitory computer readable storage medium of claim 11, wherein deactivating fine-grain gesture recognition mode raises the gesture recognition threshold.

13. A wearable device comprising:
at least one sensor;
a processor configured to:
receive signal data from the at least one sensor that exceeds a gesture recognition threshold;
compare the received signal data to stored signal data representing an initialization gesture;
activate a fine-grain gesture recognition mode if the received signal data matches the stored signal data, the fine-grain gesture recognition mode lowering the gesture recognition threshold; and
provide, concurrent with the activation of the fine-grain gesture recognition mode, visual or haptic feedback to the user indicating that the initialization gesture has been recognized.

14. The wearable device of claim 13, wherein the gesture recognition threshold is determined by a comparison of the received signal data to signals generated as a result of natural body movement.

15. (canceled)

16. The wearable device of claim 13, wherein the processor is further configured to receive additional signal data from the at least one sensor that exceeds the lowered gesture recognition threshold.

17. The wearable device of claim 13, wherein the processor is further configured to:
receive additional signal data from at least one sensor that exceeds the gesture recognition threshold;
compare the received additional signal data to stored signal data representing a deactivation gesture; and
deactivate fine-grain gesture recognition mode if the received additional data matches the stored data representing the deactivation gesture.

18. The wearable device of claim 18, wherein deactivating fine-grain gesture recognition mode raises the gesture recognition threshold.

19. The method of claim 1, wherein the initialization gesture comprises detecting tapping three times on a screen of the wearable device.

20. The method of claim 1, wherein the initialization gesture comprises detecting movement of an arm for a hand of a user of the wearable device upwards fully followed by downwards fully.

21. The method of claim 5, wherein the deactivation gesture comprises detecting that the wearable device is at a position in which the wearable device is not usable by a user wearing the wearable device.
